(19) United States
(12) Patent Application Publication
(10) Pub. No.: US 2017/0242948 A1
(43) Pub. Date: Aug. 24, 2017

(54) SENSITIVITY ANALYSIS SYSTEMS AND METHODS USING LOCAL GRADIENTS

(71) Applicant: Infineon Technologies AG, Neubiberg (DE)

(72) Inventors: Ingrid Kovacs, Satu Mare (RO); Andi Buzo, Bucharest (RO); Monica Rafaila, Munchen (DE); Georg Pelz, Ebersberg (DE); Marina Dana Topa, Cluj (RO)

(21) Appl. No.: 15/047,829

(22) Filed: Feb. 19, 2016

(51) Int. Cl. G06F 17/50

(52) U.S. Cl. CPC G06F 17/5036

(57) ABSTRACT

A sensitivity analysis arrangement using local gradients is disclosed. The arrangements include a design of experiments component, a simulation/measurement component and an analysis component. The design of experiments component is configured to generate a set of factors of a response for a device and to generate a design of experiments using the set of factors. The simulation component is configured to obtain response values for the design of experiments and the set of factors. The controller is configured to determine a reduced set of relevant factors based on the response values using local gradients. The reduced set of relevant factors is a subset of the factors.

### BACKGROUND

Devices, products and systems typically undergo verification during and/or after production. The verification can be used to assess whether requirements are met, determine failures, characterize the device and the like.

However, the devices, products and systems are continuously growing in complexity. As a result, verification likewise grows in complexity. Thus, the verification and verification processes require substantial costs in terms of time, verification hardware and/or processing power.

Techniques are needed to characterize complex devices, products and systems without requiring substantial time, hardware and/or processing power.

### BRIEF DESCRIPTION OF THE DRAWINGS

FIG. 1 is a block diagram illustrating a device production and verification system.

FIG. 2 is a diagram illustrating a device subjected to sensitivity analysis using local gradients.

FIG. 3 is a block diagram of a sensitivity analysis arrangement using local gradients.

FIG. 4A is a graph showing an example of linear regression.

FIG. 4B is another graph showing an example of local linear regression.

FIG. 5 is a flow diagram illustrating a method of determining a reduced set of relevant factors by performing sensitivity analysis using local gradients.

FIG. 6A is a table illustrating an example of a design of experiments that can be developed.

FIG. 6B is a table illustrating an example of simulations for a design of experiments that can be developed.

FIG. 6C is a graph showing an example of local linear regression showing a subset.

FIG. 6D is a graph showing an example of local linear regression and generation of regression coefficients.

FIG. 6E is a table illustrating an example of factor effects, including simple effects or higher order effects.

### DETAILED DESCRIPTION

The present invention will now be described with reference to the attached drawing figures, wherein like reference numerals are used to refer to like elements throughout, and wherein the illustrated structures and devices are not necessarily drawn to scale.

As utilized herein, terms “component,” “system,” “interface,” and the like are intended to refer to an electronic circuit, computer-related entity, hardware, software (e.g., in execution), and/or firmware. For example, a component can be an analogue electronic circuit, a digital electronic circuit, a mixed-signal electronic circuit, a processor (e.g., a microprocessor, a controller, or other processing device), a process running on a processor, a controller, an object, an executable, a program, a storage device, a computer, a tablet PC, and/or a mobile phone with a processing device. Some other examples of a component include a voltage regulator that provides power for various loads, including loads in automotives, a processor or circuitry in automotive electronics, a processor or circuitry located on a credit card, a switch that drives a valve in an anti-lock braking system (ABS), a switch that drives an electric motor, a pressure sensor, a pressure sensor for an airbag system, a current sensor, a current sensor in an electrical power steering (EPS) system and the like. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” may refer to, be part of, or include an Application Specific Integrated Circuit (ASIC), an analogue electronic circuit, an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

A verification level for a device (or devices) is a level or process point where performance of the device is verified. The verification level can occur at one or more points or levels of production. The device can include, for example, a device, product, system, pre-silicon level, post-silicon level and the like.

The verification is performed on the device to assess that requirements are met, pass/fail all or portions of the device, identify failures, determine causes of failure, determine root causes of failure, characterize the device, predict behavior, predict behavior for untested scenarios and the like.

Devices continue to increase in performance, complexity, provided features and the like. As a result, the verification also increases in complexity. For example, the number of requirements, characterization and the like also increases in complexity.

Factors that impact the performance of devices are typically identified and tested to facilitate verification. The performance includes one or more responses to the factors. The factors that impact the performance of devices include, for example, input stimuli, device parameters, system parameters, production process variation, operating conditions, tool variations and the like. As the complexity of devices increases, so do the number of factors that impact performance. These factors are referred to as performance factors. For example, a given device can have a thousand or more performance factors.

It is appreciated that testing for all possible performance factors could be cost prohibitive. Thus, an analysis, referred to as sensitivity analysis, is performed to identify a smaller set of more relevant factors. Sensitivity analysis includes the study of how the uncertainty in the output of a mathematical model or system (numerical or otherwise) can be apportioned to different sources of uncertainty in its inputs. Once the analysis is performed, verification, including characterization, is performed using the smaller or reduced set of factors thereby allowing verification to be performed with reduced complexity and within a suitable time.

A technique for performing sensitivity analysis using local gradients is described. The technique facilitates identification of the more relevant factors. As a result, the number of measurements and/or simulation runs needed for verification of a system is reduced. The identification of causes of failures is facilitated. Requirements, such as critical responses, are strongly related to the more relevant factors and can, as a result, be identified and causes of failures identified.

Some other sensitivity analysis techniques include a one factor at a time (OAT) approach, variance based methods, linear regression and classical approaches. In the OAT approach, each factor is varied in turn while the rest of the factors are maintained at a fixed value. Generally, each factor is tested with a limited number of samples. This approach can identify the impact of individual factors. However, this approach does not consider interactions between factors. Additionally, the accuracy in determining the impact of each factor is typically low due to limited number of samples.

The variance based methods attempt to determine the amount of variation in a response caused by each factor. This is obtained using special experiment plans where those/these factors are changed after a predetermined pattern for each run, whether a simulation or measurement. The patterns are selected so that the decomposition of the effects of different factors is possible. However, the variance based methods require a relatively high number of runs, impose an experiment plan that is only useful for a particular analysis and the factors need to be orthogonal (i.e., no correlation can be induced).

The linear regression approach aims at estimating a relationship/law between a response and the factors. To determine the relationship, statistical linear regression is used. Once the relationship is determined with suitable confidence, a deeper analysis can be performed. However, this approach is based on finding an appropriate function to fit the relationship and the accuracy of the fit. A lack of fitness is common.

The classical approaches include a number of approaches. An analysis of variance (ANOVA) approach requires a high number of runs, huge computation power and its own experimental plan. A correlation method is based on linear correspond of a response with factors. The correlation method only detects linear effects. Matrix scatter plots are another approach and can reveal factor-response relationship, but require human intervention to judge impact of the factors on the response.

There are several disadvantages of the other approaches. They require a large number of evaluations, which is dependent on the number of factors. The approaches only account for a limited number of effects, such as linear or first order effects. They impose their own design of experiment; the simulated/measured results can only be used for the particular approach.

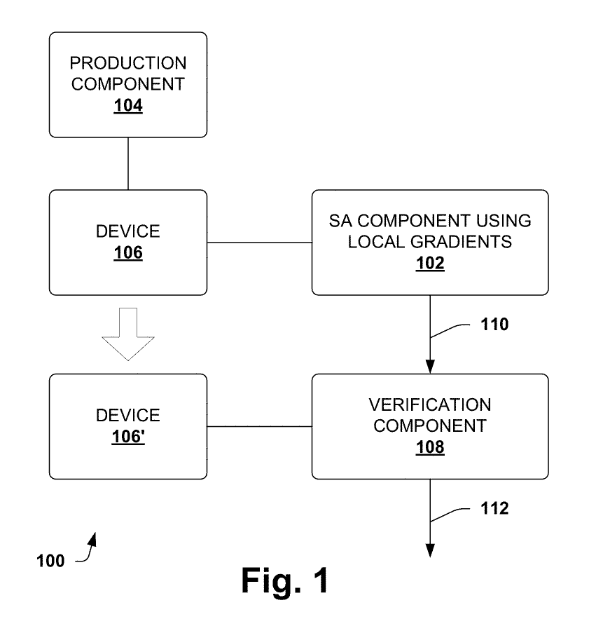

FIG. 1 is a block diagram illustrating a device production and verification system 100. The system 100 performs sensitivity analysis using local gradients. The sensitivity analysis identifies a set of more relevant factors that are used for verification.

The system 100 includes a sensitivity analysis component 102, a production component 104, and a verification component 108. The system 100 operates or acts on a device 106. The device 106 includes semiconductor based devices or chips at various stages of fabrication, including at completion. The device 106 can be incorporated or used in systems, such as automotive systems, computer systems and the like.

The production component 104 includes tools, equipment and the like utilized to fabricate the device 106. In one example, the production component 104 includes fabrication tools for performing one or more semiconductor fabrication processes. In another example, the production component 104 includes electronic design and automation (EDA) tools.

The verification component 108 is configured to perform verification testing on the device 106′ using a reduced set of relevant factors 110. The verification component 108 is configured to generate test results 112 based on the verification testing of the device 106. The reduced set of relevant factors 110 facilitate performing the verification testing in a suitable or reasonable time period with a reduced complexity while obtaining the tests results 112 that verify performance based on the relevant factors 110.

The device 106 has one or more responses based on a relatively high number of factors. The responses can include, for example, output voltage, maximum output voltage, chip temperature, maximum output current, switching delay, slew rate, analog to digital conversion error and the like. Each response varies according to the factors. For example, a response of an output voltage can have different values, referred to as response values, based upon the factors and variations of the factors, where the factors include, for example, input voltage, temperature and the like. The relatively high number of factors can number in the thousands, as an example. The factors can include input stimuli, process variations, operating conditions, design parameters and the like.

The factors and responses can be related to or associated with a variety of applications including, for example, a voltage regulator that provides power for various loads, a voltage regulator that provides power to automotive loads, a processor or circuitry in automotive electronics, a processor or circuitry located on a credit card, a switch that drives a valve in an anti-lock braking system (ABS), a switch that drives an electric motor, a pressure sensor, a pressure sensor for an airbag system, a current sensor, a current sensor in an electrical power steering (EPS) system and the like. It is appreciated that the factors and responses can also be related to or associated with other applications.

Each response varies according to changing values of the factors. However, some of the factors have a larger role in a given response than others. Additionally, some factors can act together. While still other factors have a relatively small or no impact on the given response.

The sensitivity analysis component 102 is configured to determine or identify the reduced set of relevant factors 110 that impact a response. The reduced set 110 is typically substantially smaller than all the possible factors. For example, the reduced set 110 may include 5 factors whereas the number of possible factors is over 100.

The sensitivity analysis component 102 is configured to perform sensitivity analysis on the device 106 using local gradients to determine the reduced set of relevant factors 110. The reduced set 110 provide the substantial variation in the response.

Additionally, the performed sensitivity analysis reduces the verification space (numbers of factors), provides failure discovery, provides effect discovery, provides an increased understanding of the device 106 and the like.

The relationship between the response and factors, also referred to as a response-factors function, can be viewed as a hyper surface in multidimensional space. A small region of the hyper-surface can be approximated with a plane. The plane will be tangent to a surface and its orientation is given by the gradient of the surface in a surrounding region. The value or orientation of the gradient indicates the factors that cause the variation in the response. The accumulation of the effects from different regions gives a measure of the global impact that a factor have on the response. The factors are then provided as the reduced set of relevant factors 110. Additional details on this approach are provided below.

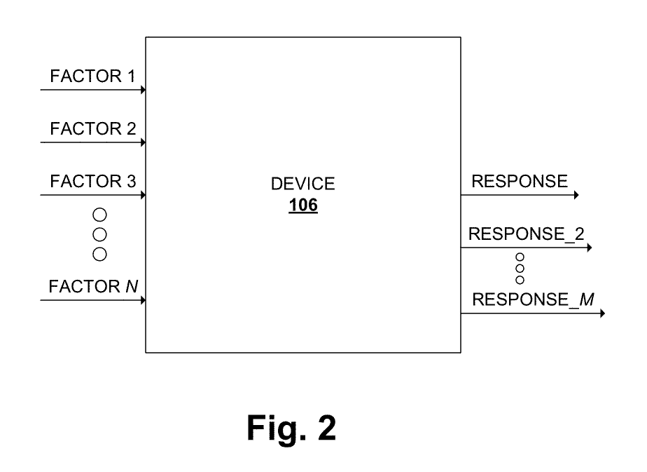

FIG. 2 is a diagram illustrating a device 106 subjected to sensitivity analysis using local gradients. The device 106 is provided as an example and it is appreciated that other suitable devices can be employed.

The device 106 includes semiconductor based devices or chips at various stages of fabrication, including at completion. The device 106 can be incorporated or used in systems, such as automotive systems, computer systems and the like.

The device 106 is shown with N possible factors one or more responses M or a set of responses. The factors can include input stimuli, process variations, operating conditions, design parameters and the like. The response can include, for example, output voltage, maximum output voltage, chip temperature, maximum output current, switching delay, slew rate, analog to digital conversion error and the like. The number N can be relatively large, such as N=100, N=1,000 and the like. The response values for each response vary based on changes to the factors.

As shown above, the sensitivity analysis component uses local gradients to determine a local or estimated response-factors function for each response. These functions are then used to reduce the number of factors to a smaller or reduced set of relevant factors.

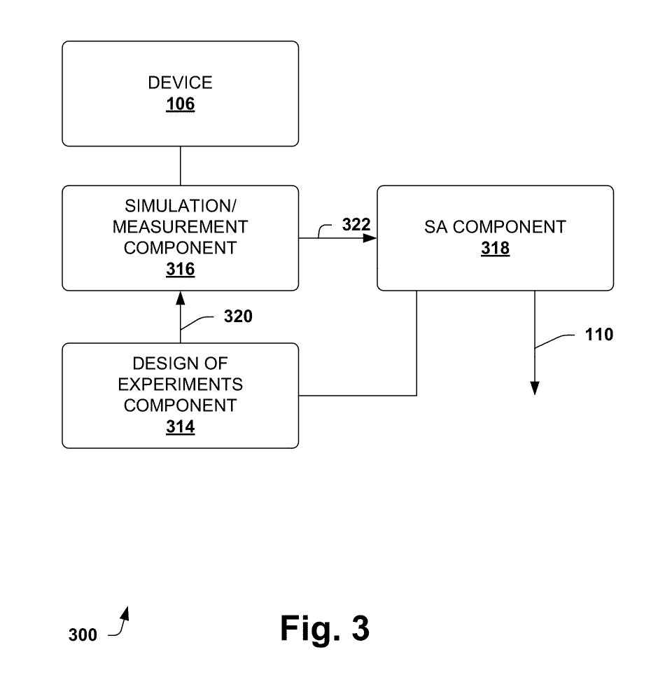

FIG. 3 is a block diagram of a sensitivity analysis arrangement 300 using local gradients. The arrangement 300 is provided as an example of a suitable sensitivity analysis component that can be used as the component 102 in the system 100 and in other aspects or embodiments. It is appreciated that variations in the arrangement 300, including or omitting components, is contemplated.

The arrangement 300 includes a design of experiments (DoE) component 314, a simulation/measurement component 316 and a sensitivity analysis computation component 318. The arrangement 300 operates on devices, such as the device 106, to identify a reduced set of relevant factors 110 that can be used for verification and/or characterization.

It is appreciated that the components of the arrangement 300 can be combined into single components and/or circuitry and/or their functionality placed in other components.

The DoE component 314 is configured to determine a set of factors or varying factors for a response. The set of factors can include all possible factors. The DoE component 314 is also configured to select a design of experiments for the set of factors. Each of the set of the design of experiments includes values or ranges for individual factors of the set of factors and the like. For example, a factor based on an input signal can be set to vary from 0 to 5 volts. In one example, a matrix of various values for the factors is generated as the selected set of design of experiments.

In one example, the DoE component 314 is configured to select the design of experiments according to a user or requestor. In another example, the DoE component 314 is configured to select the design of experiments that is not imposed by the user or requestor, but which can be imposed by test setup constraints.

The simulation/measurement component 316 is configured to simulate or measure response values of a response for each of the factors and the selected set of design of experiments. The response values, also referred to as samples, can be arranged in a matrix or other suitable data structure. In one example, the responses are generated by simulation using a model representing behavior of a device. In another example, the responses are measured using one or more devices wherein inputs are applied to the device according to the selected set of design of experiments.

The SA component 318 is configured to use local gradients to generate a reduced set of relevant factors 110 for the response based on the response values or samples provided by the simulation/measurement component 316. The reduced set of factors 110 is a subset of the possible or initial factors.

The SA component 318 identifies a subset of points to use for local regression. The size of the subset can vary. Additional subsets of points are generates so that a plurality of subsets are generated. A linear regression is performed for each subset. A gradient for each linear regression is performed, where the gradient measures an impact of that factor on the response. The gradients, also referred to as factor impact measurements, are analyzed to determine the reduced set of relevant factors 110. The reduced set of relevant factors 110 is also referred to as a set of important factors.

In one example, the reduced set 110 is determined by selecting factors having factor impact measurements above a threshold value. In another example, a number or percentage of factors that provide the greatest impact are used. Other techniques for selecting or determining the reduced set 110 are contemplated.

The reduced set of relevant factors 110 can then be provided to other components, such as a verification component, to perform verification and/or characterization of devices. It is appreciated that the arrangement 300 can be used to obtain additional reduced sets of relevant factors for additional responses.

A mathematical example of a suitable technique that can be used by the SA component 318 and other aspects or embodiments is disclosed. A device is characterized by a response or response variable denoted by Y. The response variable Y is given by:

Y=f(X₁, . . . ,X_{K})+ε

Where there are K input factors X. Random error is represented by ε, which is typically present in measurements, but not simulations.

The goal is to find the subset of k factors {X₁, . . . , Xₖ} that have the greatest impact on Y.

The approach uses statistical regression and a metamodeling concept. For complex models, the response typically varies much and in a non-monotonic manner as a function of the factors. The metamodeling is suitable for regions of the response where there is not a relatively large amount of variance. If there is, higher order effects may not be caught.

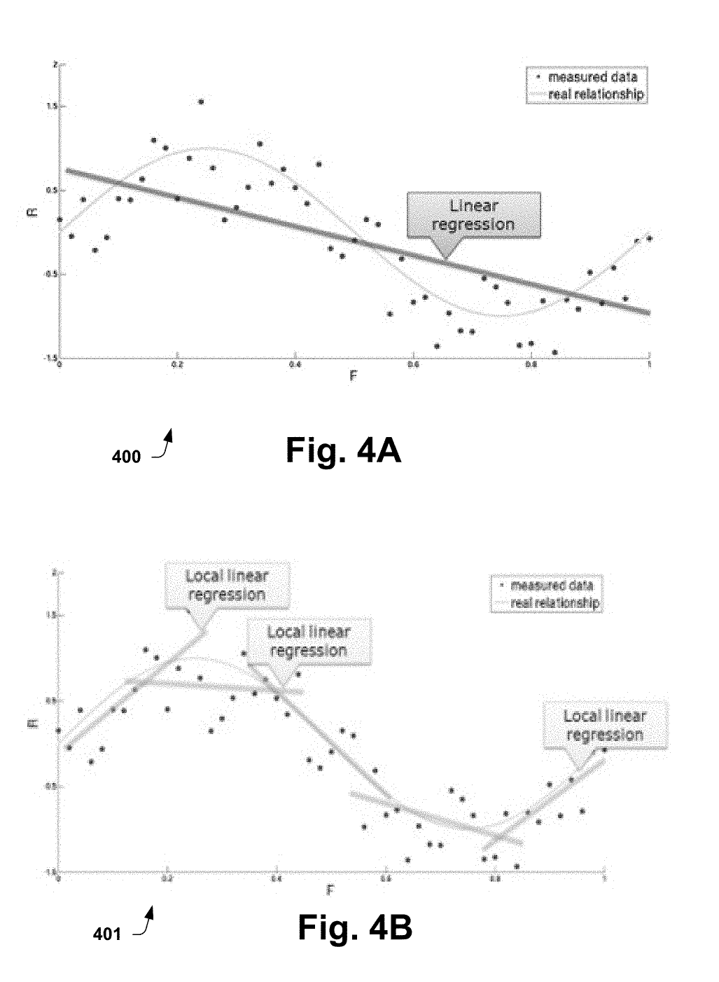

FIG. 4A is a graphic 400 showing an example of linear regression. The graphic is provided as an example for illustrative purposes. An x-axis depicts values for a factor from zero to larger values. A y-axis depicts response values.

Measured or simulated samples are shown as dots. A curved line shows an actual response-factor relationship. A line shows linear regression based on the samples. It can be seen that the linear regression is insufficient to capture some of the effects of the response-factor relationship. Thus, the linear regression approach would be insufficient for this response-factor relationship.

FIG. 4B is another graphic 401 showing an example of local linear regression. The graph is provided as an example for illustrative purposes. An x-axis depicts values for a factor from zero to larger values. A y-axis depicts response values.

Measured or simulated samples are shown as dots. A curved line shows an actual response-factor relationship. Instead of a single line for all the samples, multiple or local lines are shown for local linear regression. The local linear regressions more accurately capture the behavior of the response-factor relationship.

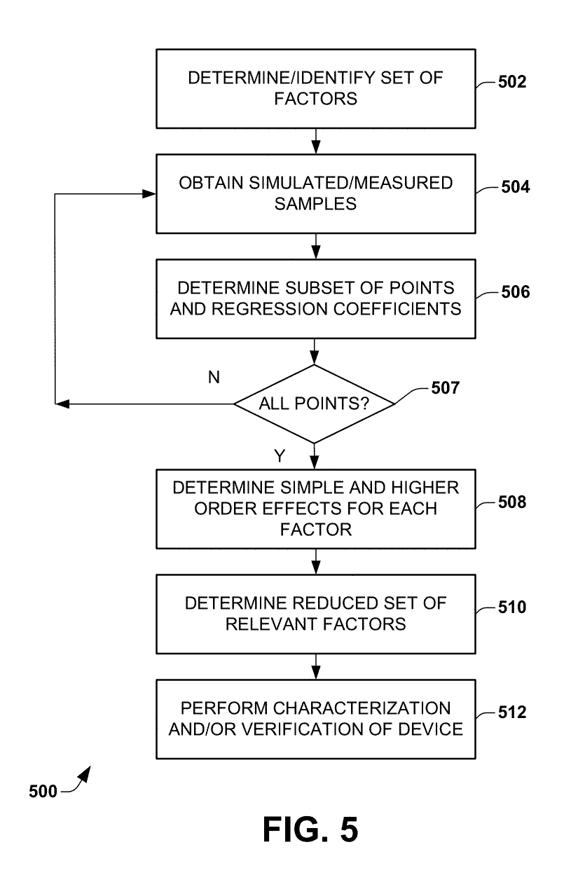

FIG. 5 is a flow diagram illustrating a method 500 of determining a reduced set of relevant factors for a response by performing sensitivity analysis using local gradients. The method 500 performs local linear regression to determine the impact of factors on a response. The impact is then used to identify a reduced set of factors.

A set of varying factors {X₁, . . . , X_{K}} of associated with a system/device are determined at block 502. Additionally, a design of experiments is selected, using the set of varying factors. The design of experiments can be selected based on previous knowledge about the device. In one example, a Monte Carlo (MC) approach is used where N is the number of simulations selected for the MC design.

The device includes semiconductor based devices or chips at various stages of fabrication, including at completion. The device can be incorporated or used in systems, such as automotive systems, computer systems and the like. The factors can include input stimuli, process variations, operating conditions, design parameters and the like.

In one example, the design of experiments component 314 or variations thereof is configured to determine the set of varying factors and select the design of experiments.

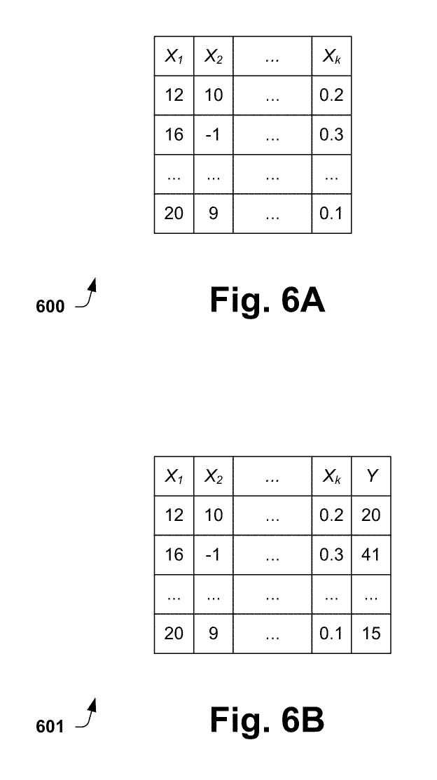

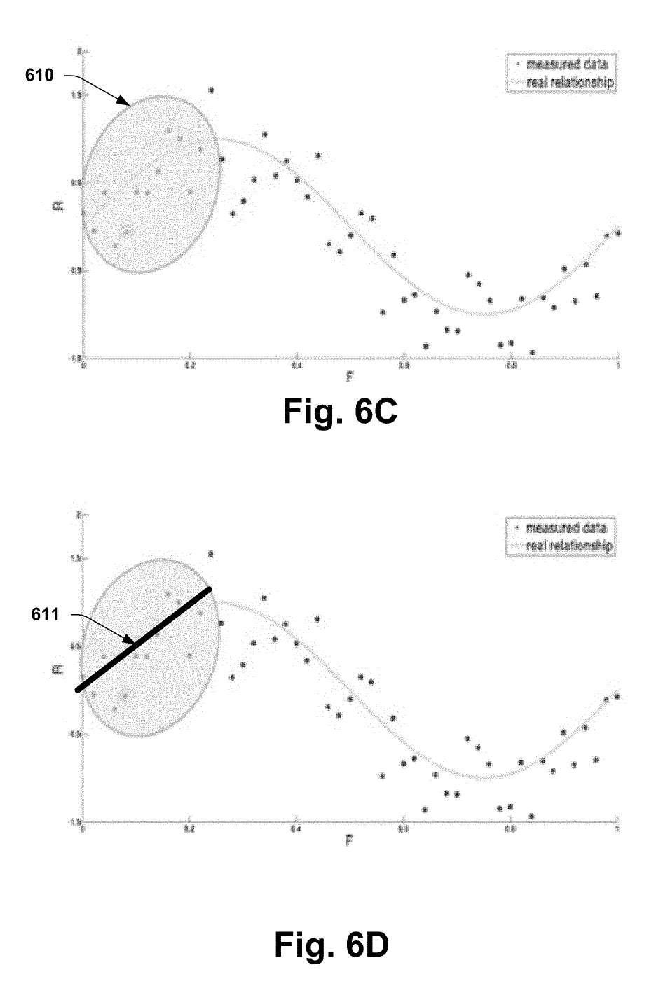

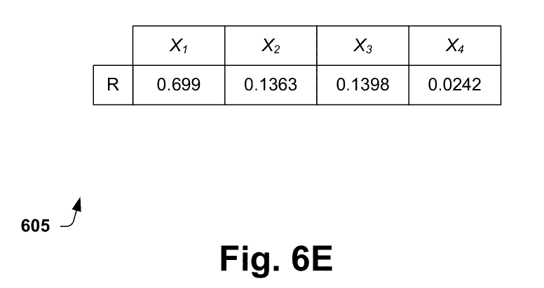

FIG. 6A is a table 600 illustrating an example of a design of experiments that can be developed using the block 502 of the method 500. The table 600 is provided for illustrative purposes. The table 600 has K factors with various sets of factor values arranged in rows. The design of experiments is shown with values and a number of sets of factor values for illustrative purposes. It is appreciated that the design of experiments can include other values, omit sets, and/or include additional sets of factor values.

Simulations or measurements are determined using the selected design of experiment to generate response values for the response at block 504. The set of factors values is determined at block 502 and the factor values are used to generate a response based on the factor values. The response values are generated via simulation or by measurement.

The response can include, for example, output voltage, maximum output voltage, chip temperature, maximum output current, switching delay, slew rate, analog to digital conversion error and the like. The response values vary according to the set of factor values.

In one example, the simulation/measurement component 316 is configured to generate the response values by simulation and/or measurement.

FIG. 6B is a table 601 illustrating an example of simulations for a design of experiments for a response that can be developed using the block 504 of the method 500. The table 601 is provided for illustrative purposes. The table 601 also has K factors with various sets of factor values arranged in rows and a corresponding response value Y. It is appreciated that the design of experiments can include other values, response values, omit sets, and/or include additional sets of factor values.

For each point of the K-dimensional verification space, the closest q points are found and regression coefficients are determined at block 506. The regression coefficients are denoted as {β₁, . . . , β_{K}}_{subset i}. In one example, a sensitivity analysis computation component, such as the component 318 described above, is used to find the closest points and generate the regression coefficients.

FIG. 6C is a graph showing an example of local linear regression showing a subset. The subset includes the closest and/or nearest points. The graph is provided as an example for illustrative purposes. An x-axis depicts values for a factor from zero to larger values. A y-axis depicts response values.

Measured or simulated samples are shown as dots. A curved line shows an actual response-factor relationship. An oval 610 shows an example of the q closest points or samples to a current sample.

FIG. 6D is a graph showing an example of local linear regression and generation of regression coefficients. The graph is provided as an example for illustrative purposes. An x-axis depicts values for a factor from zero to larger values. A y-axis depicts response values.

Measured or simulated samples are shown as dots. A curved line shows an actual response-factor relationship. A line 611 illustrates an example of a local linear regression based on the q closest points or samples to a current sample. Regression coefficients are generated for the q closest samples.

Blocks 504 and 506 of the method 500 are repeated for all points in the verification space at block 507.

Once complete or repeated for all points, the simple effect and higher order effect of each factor is determined at block 508. The simple effect of a factor, denoted as Xᵢ (Seᵢ) is determined as a mean of an absolute partial regression coefficients obtained from the N subsets while the higher order effect (Heᵢ) is their variance. In one example, a sensitivity analysis computation component, such as the component 318 described above, is configured to determine the factor effects including the simple effects and the higher order effects of each factor.

$${Se}_{i} = {μ}_{i} = \frac{1}{N} {\sum }_{i = 1}^{N} \vert {β}_{i} \vert \\ {He}_{i} = {σ}_{i}^{2} = \frac{1}{N} {\sum }_{j = 1}^{N} {( {β}_{j} - μ )}^{2}$$

Where μ is the average over all μᵢ. It is also noted that higher values of Seᵢ and Heᵢ indicate a greater impact of Xᵢ on Y.

FIG. 6E is a table 605 illustrating an example of factor effects, such as simple effects or higher order effects. In this example, there are four factors shown and associated effects. It can be seen that their effect on the response varies for each factor.

A reduced subset of relevant factors is determined at block 510. The factor effects are analyzed or compared to determine which factors to include in the reduced set or subset. In one example, factor effects having a value above a threshold are included in the reduced set. In another example, a percentage of the factors having the highest factor effects are selected.

As an example, the factor effect for X1 of FIG. 6E is substantially higher than the other factor effects and is selected for inclusion in a reduced set of relevant factors.

Verification and/or characterization of a device is performed at block 512. The verification is performed using the reduced set of relevant factors generated at block 510. The verification can also be performed on one or more additional devices.

The verification can indicate, for example, whether the subject device meets operating requirements, has defects, fails requirements, and the like. The reduced set of relevant factors also facilitates identification of causes of defects or failures.

It is appreciated that variations of the method 500 are contemplated, such as including functionality and features of the above described arrangements and systems. Further, the method 500 can be utilized to obtain additional reduced sets of relevant factors for additional responses.

While the method is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature may have been disclosed with respect to only one of several implementations, such feature may be combined with one or more other features of the other implementations as may be desired and advantageous for any given or particular application.

It is appreciated that the claimed subject matter may be implemented as a method, apparatus, or article of manufacture using standard programming and/or engineering techniques to produce software, firmware, hardware, or any combination thereof to control a computer to implement the disclosed subject matter (e.g., the systems, arrangements and the like shown in FIGS. 1, 2, etc., are non-limiting examples that may be used to implement the above methods). The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

A sensitivity analysis arrangement using local gradients is disclosed. The arrangements include a design of experiments component, a simulation/measurement component and an analysis component. The design of experiments component is configured to generate a set of factors of a response for a device and to generate a design of experiments using the set of factors. The simulation component is configured to obtain response values for the design of experiments and the set of factors. The controller is configured to determine a reduced set of relevant factors based on the response values using local gradients. The reduced set of relevant factors is a subset of the factors.

A sensitivity analysis and verification arrangement is disclosed. The arrangement includes a sensitivity analysis component and a verification component. The sensitivity analysis component is configured to use local gradients to generate a reduced set of relevant factors from a set of factors for a device. The verification component is configured to perform verification using the reduced set of relevant factors.

A method of performing sensitivity analysis using local gradients is disclosed. A set of factors are determined for a device. A design of experiments is selected for the set of factors and the device. The design of experiments includes sets of factor values. Samples for the design of experiments are obtained. The samples are responses based on the sets of the factor values. Subsets of points are determined for the samples. Regression coefficients are determined for each of the subsets. Factor effects are determined for each factor of the set of factors based on the regression coefficients.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A sensitivity analysis arrangement using local gradients comprising:
a design of experiments component configured to generate a set of factors of a response for a device and to generate a design of experiments using the set of factors;
a simulation/measurement component configured to obtain response values for the design of experiments and the set of factors; and
an analysis component configured to determine a reduced set of relevant factors based on the response values using local gradients, where the reduced set of relevant factors is a subset of the factors.

2. The arrangement of claim 1, wherein the set of factors includes input or stimuli variation, process variations, design parameters, intermediate outputs and operating conditions.

3. The arrangement of claim 1, wherein the response is one of an output voltage, an output current, and chip temperature.

4. The arrangement of claim 1, wherein the set of factors includes over 1,000 factors.

5. The arrangement of claim 1, wherein the reduced set of relevant factors includes only the top five factors of the set of factors, based on the local gradients.

6. The arrangement of claim 1, wherein the design of experiments includes a plurality of factors and a plurality of sets of factor values.

7. The arrangement of claim 1, wherein the design of experiments is formed as a table.

8. The arrangement of claim 1, wherein the simulation/measurement component is configured to measure the response values of the device.

9. The arrangement of claim 1, wherein the simulation/measurement component is configured to obtain the response values by simulation of a model of the device.

10. The arrangement of claim 1, wherein the analysis component is configured to determine factor effects for each factor of the set of factors using the local gradients.

11. The arrangement of claim 10, wherein the analysis component is further configured to determine the reduced set of relevant factors according to the factor effects.

12. The arrangement of claim 10, wherein the factor effects include simple effects and higher order effects.

13. A sensitivity analysis and verification arrangement comprising:
a sensitivity analysis component configured to use local gradients to generate a reduced set of relevant factors from a set of factors for a device; and
a verification component configured to perform verification using the reduced set of relevant factors.

14. The arrangement of claim 13, wherein the performed verification includes pass/failure for device specifications.

15. The arrangement of claim 13, wherein the performed verification includes fault identification.

16. The arrangement of claim 13, wherein the sensitivity analysis component is configured to determine a plurality of subsets of points and generate the local gradients for each subset.

17. The arrangement of claim 16, wherein the sensitivity analysis component is configured to generate gradient coefficients for the plurality of subsets of points and to determine factor effects for each factor of the set of factors based on the gradient coefficients.

18. A method of performing sensitivity analysis using local gradients, the method comprising:
determining a set of factors for a device;
selecting a design of experiments for the set of factors, wherein the design of experiments includes sets of factor values;
obtaining samples for the design of experiments, wherein the samples are responses based on the sets of the factor values;
determining subsets of points for the samples;
determining regression coefficients for each of the subsets; and
determining factor effects for each factor of the set of factors based on the regression coefficients.

19. The method of claim 18, further comprising determining a reduced set of relevant factors based on the factor effects.

20. The method of claim 19, further comprising performing characterization and/or verification of a device.
